(19) United States
(12) Patent Application Publication
(10) Pub. No.: US 2015/0024725 A1
(43) Pub. Date: Jan. 22, 2015

(54) LOCATION TAGGING PHONE CALLS FOR ONE-TO-ONE, CONFERENCE, AND CALL CENTER CALLS

(71) Applicants: Alexander Chris Lang, Singapore (SG); Chathoth Vijayan Bindu, Marine Park Road (SG)

(72) Inventors: Alexander Chris Lang, Singapore (SG); Chathoth Vijayan Bindu, Marine Park Road (SG)

(21) Appl. No.: 14/247,738

(22) Filed: Apr. 8, 2014

(30) Foreign Application Priority Data
Apr. 8, 2013 (SG) 201302721-4

(51) Int. Cl. H04W 4/16; H04W 4/02

(52) U.S. Cl. CPC H04W 4/16; H04W 4/021; H04L 12/189
USPC 455/417

(57) ABSTRACT

A subscriber-based calling communications system and method for mobile devices that utilizes call request packets of a plurality of formats including caller location coordinates to enable call setup including the caller's location such that long distance or local call service providers can provide caller location information to the recipient call center or the called party and at the same time, automate subscriber call setup and subscriber call forwarding based on the subscribers known mobile device location.

The present application claims the benefit of Singapore Patent application No. 201302721-4, filed Apr. 8, 2013, the disclosure of which is hereby incorporated by reference in its entirety.

### BACKGROUND OF THE INVENTION

1. Field of the Invention

The invention described herein generally relates to the provision of location coordinates with packet originated phone calls.

2. Description of the Related Art

It is known in the prior art for a long distance service provider (LDSP) to provide long distance telephone services to customers by originating telephone calls in response to request messages sent through the Internet by the customer. The related U.S. Pat. No. 6,879,678 describes an exemplary method for initiating toll call connections from a Worldwide Web server. U.S. Pat. No. 6,879,678 describes a personal communications assistant (PCA) or mobile device used to initiate a toll connection by issuing a call request message that is sent through the Internet to the LDSP. The call request message is initiated by a subscriber providing instruction(s) to a call completion application that resides on the PCA.

It is also well known in the prior art that request message packets can take the form of any message format capable of providing the LDSP the required information to create a call session, which is described in the related U.S. Pat. No. 6,694,007. U.S. Pat. No. 6,694,007 describes an exemplary method for initiating call connections using any request message protocol including but not limited to Short Message Service (SMS) to Instant Messaging (IM) to E-Mail where special information can be included in the message to identify the problem to be discussed or agent to be connected to.

It is also well known in the prior art that the request message packets can take the form capable of creating a toll free call session designed to interface call centers, described in related U.S. Pat. No. 7,636,430 B2, which describes an exemplary method for initiating call connections specifically to a call center using request packets, and related U.S. Patent Publication No. 2009/0093240 describes an exemplary method for joining conference calling sessions using SMS messages.

Existing methods do not include subscriber location coordinates in the call request packet, or using location coordinates to automate the selection of PCA origination numbers and manage automatic call forwarding to a subscriber based on his/her location coordinates when launching a call session from a PCA or manually sending an SMS message to create a call session or using a call request packet (SMS) to join a conference call or a call request packet to connect to a caller to a call center. As such, there is a need to associated subscriber location coordinates with a PCA.

### SUMMARY OF THE INVENTION

The present invention provides a method and system for associating location coordinates with originating phone numbers so that when a subscriber using a PCA client travels, the PCA's origination number automatically changes based on the subscriber's location. By location coordinate tagging some or all of the originating numbers in an originating number directory, the correct origination number can be automatically selected as the subscriber moves from place to place. The automatic selection of origination numbers will ensure that as the PCA subscriber places calls they have the correct origination number selected. This becomes important when the PCA automatic call forward feature is used.

It is another object of invention to provide the LDSP subscriber current origination numbers so that if a second subscriber sends a call request packet to the LDSP, then the second subscriber call to a first subscriber can be automatically re-routed to the first subscriber's current origination number with the major benefit of eliminating inbound roaming fees automatically as each subscriber connects to the other subscriber's current origination number automatically. Origination numbers that are location tagged change automatically and update the LDSP automatically as well, subscribers can keep in touch with each other connecting to subscriber current origination numbers automatically.

It is yet another object of the invention to provide Public Switched Telephone Network (PSTN)-connected calling devices access to a LDSP subscriber origination number database such that calls can be rerouted to a subscriber origination number eliminating inbound roaming fees and ensuring that the subscriber is always in reach of all callers no matter what the subscriber's origination number is. Forwarding a mobile device to a LDSP PSTN Direct in Dial (DID) phone number ensures that anyone calling the mobile device will reach the DID number. The provider of the DID number, cross references to the subscriber origination number database to determine the subscriber origination number and forwards the DID number to the origination number. Since origination numbers are location tagged, according to embodiments of the present invention, anyone calling the subscriber mobile device number automatically follows the subscriber current origination number, eliminating most inbound roaming charges and ensuring continued voice connectivity everywhere no matter what origination number is used.

It is another object of invention to provide a facility where the PCA client sends an “allow automatic forwarding” instruction to the LDSP, before the automatic call forwarding feature would be implemented by the LDSP, ensuring privacy as required.

It is yet another object of invention to optionally provide callers re-directed messages when callers' calls to subscribers are re-directed. The re-direct message can be a voice message for the public who do not have access to a PCA client and a pop-up message for a PCA subscriber.

It is yet another object of the invention to provide subscriber location coordinates to call center agents.

It is an object of the invention to provide the subscriber the ability to select a zone in which the subscriber origination number is tagged for inclusion in location based call forwarding schemes, and forwarding of location coordinates to call centers and the called party.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A illustrates a drop down directory where a subscriber can select from a list of subscriber frequently used phone numbers as origination numbers for PCA initiated calls according to an embodiment of the present invention;

FIG. 1B illustrates a drop down directory where each number has a location tag according to an embodiment of the present invention;

FIG. 2 illustrates settings for an origination phone number according to an embodiment of the present invention;

FIG. 3 illustrates a location zone associated with an origination number according to an embodiment of the present invention;

FIG. 4 illustrates components of a re-direct message according to an embodiment of the present invention;

FIG. 5 illustrates a flow diagram of a method for receiving redirect messages according to an embodiment of the present invention;

FIG. 6 illustrates a flow diagram of a call re-direction where a caller is re-directed to the subscriber's origination number according to an embodiment of the present invention

FIG. 7A and FIG. 7B illustrate a flow diagram of calls directed to a call center using locating tagging according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

The present invention provides a system for enabling location tagged phone calls to be originated using electronic text messages or call request packets sent from any mobile device adapted to send an electronic text message in the correct format to a LDSP by way of the Internet or appropriate message receiving gateway. Call request packets may be any of a plurality of formats that includes caller location coordinates to enable call setup including the caller's location.

### DEFINITIONS

Personal Communications Assistant (PCA) refers to a subscriber application and service that may be acquired by the subscriber by commonly and well know techniques of downloading from a mobile phone applications market or being pushed to any type of mobile computing device by a sponsoring enterprise, for example, deploying a mobile device management tool to distribute the PCA application or otherwise any method of loading the application on the mobile device without limit. A PCA client is operable on a subscriber's mobile device to create calling sessions by sending call request packets to a LDSP to simultaneously launch phone calls to an origination number and destination numbers as instructed by the information contained within the CRP to establish a connection (also known as a “callback”).

Call request packets (CRP)/call request messages refer to data packets sent from the PCA to the LDSP providing the LDSP enough information to create a calling session and can be but not limited to SMS, Unstructured Supplementary Service Data (USSD), IM, Hypertext Transfer Protocol (HTTP), TCP/IP, E-mail.

Calling session can be one-to-one voice phone calls connecting a subscriber to a destination number or destination numbers in the case of conference call.

Current origination phone number refers to a current telephone number that a subscriber uses to originate a call from a PCA to a called party(s), it is the “currently selected” origination phone number used by the subscriber to receive the PCA generated call.

Default number refers to a subscriber's “well-known” number which is usually the subscriber's main mobile phone number generally known by the subscriber's contacts as the usual number to call to connect to the subscriber by phone and the number registered in the PCA as the number that when the subscriber's PCA is reset or when the PCA does not have a proper phone number location tag.

Destination number(s) refers to the terminating telephone number of the called party and can be a PSTN number or an Internet Protocol (IP) address for an originating Time Division Multiplexing (TDM) call and a bridged terminating Voice Over Internet Protocol (VoIP) call.

LDSP is a telephone voice service provider and could be a Telco or independent telecommunications local and long distance service provider, capable of receiving call request messages from the mobile device, PCA application (or mobile device SMS messages) and interpreting the call request messages, connecting the calling (current originating number) and called party (destination number or numbers) to complete one-to-one calls or conference calls.

Location coordinates are subscriber latitude and longitude coordinates obtained by Telco tower triangulation techniques or Global System for Mobile Communications (GSM).

Geo tag or geo tagged refers to a phone number location tag, which are location coordinates assigned to an origination phone number.

Origination phone number (also herein referred to as a “MyNumber”) may be an originating number used by a subscriber of a PCA to originate calls “from” and can be a mobile device, mobile phone number, or a land line such as a subscriber home number, office number, or any PSTN or VoIP number that a PCA can originate a call on as a calling party number.

Origination phone number directory refers to a PCA drop down list or directory of subscriber originating PSTN phone numbers or VoIP address, that a subscriber may use frequently to simplify the process of PCA calls, allowing the subscriber to “tap” or select from a list to select an origination phone number to be used for PCA calls until the origination phone number is changed. The origination phone number directory can be edited by selecting the origination phone number edit feature, so that origination phone numbers can be added, deleted or updated or corrected in the origination phone number directory.

Mobile device refers to any mobile device such as mobile phone, mobile smartphone, PDA, tablet, notebook or PC or any mobile device capable of hosting and running the PCA application and sending out call request packets to the LDSP.

Phone number location tag (PNLT), PCA tag, or simply tag, refers to location coordinates associated with an origination phone number expressed in latitude and longitude. Every origination phone number or some origination phone numbers can have a location tag. As the subscriber changes location, Global Positioning System (GPS) if not in shadow, displays the location in “longitude and latitude” of the mobile device. In one embodiment, to tag an origination phone number, the subscriber selects the origination phone number directory, and a drop down list of origination phone numbers can be viewed. By selecting the tag feature and a specific origination phone number or multiple origination phone numbers, the number(s) will all be associated with the particular GPS location of the mobile device at the time of selecting the tag feature.

Public Switched Telephone Network (PSTN) may refer to a network of telephone companies who provide public telephone numbers to subscribers so they can interconnect by voice or data worldwide, each subscriber having their own unique telephone numbers for land line or mobile devices. If a device has a public phone number it is part of the PSTN. A VoIP call device can be connected to the PSTN by an appropriate gateway and in this way be part of the PSTN.

Redirect Messages refers to PCA database generated messages that inform the caller or the called party of a PCA call, when the called number is forwarded to another number. Redirect messages can be default messages such as “your call is being redirected” or the PCA subscriber by way of just one example of the embodiment, who has forwarded the called number, can go to PCA settings, select a “redirect messages” option, and enter a custom message to inform callers that the subscriber number they are calling is being re-directed to another number and provide sufficient detail to ensure the caller understands, eliminating any potential confusion when the subscriber (called party) does not answer directly (as would be the case when the call is being re-directed to a hotel number as one example where the called party would not answer the phone directly). Redirect messages can be provided to the called party by voice message during call setup, mobile device screen pop-up, or any method without limit.

Subscriber(s) can refer to any person using the PCA technology from their mobile device.

System Overview

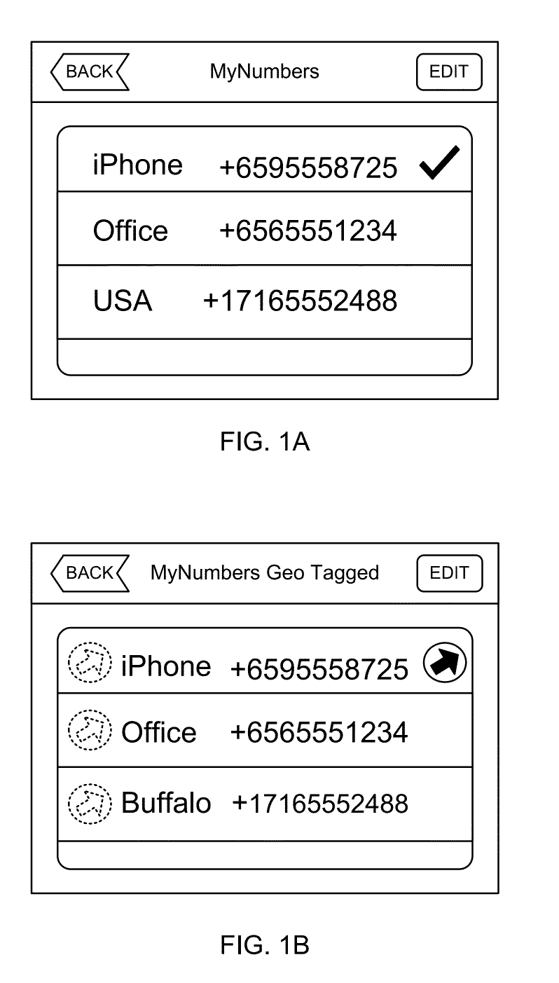

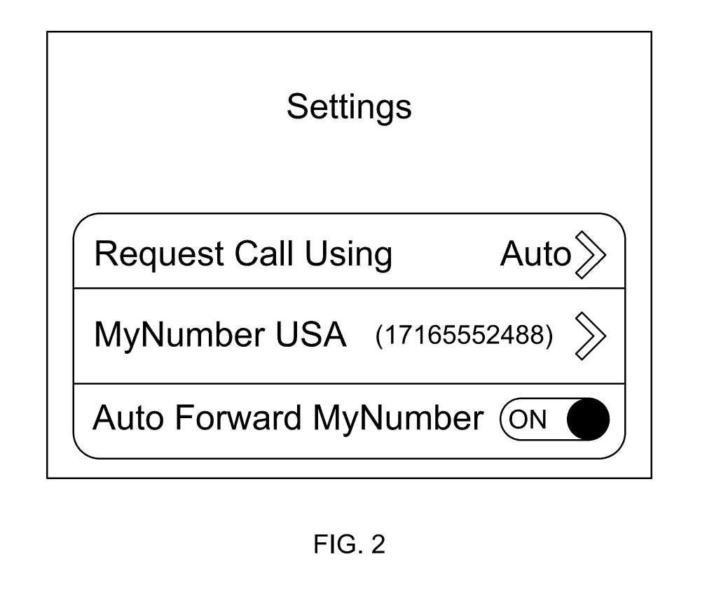

FIGS. 1A and 1B illustrate an exemplary deployment of an origination number drop down box GUI of a PCA call service client. Subscribers may place call requests using a text messaging protocol, such as an E-mail, short-message service (SMS) or instant message service (IMS). A user selects a MyNumber as the originating call number, then a destination number and pressing a dial function button to initiate a PCA call completion process that sends an appropriately formatted call request packet to the LDSP. The LDSP processes the call based on the information received in the call request packet to establish a call connection between the originating call number and the destination number.

FIG. 1A presents an origination phone number drop down directory on a mobile device where a subscriber can select from a list of subscriber frequently used origination phone numbers as origination numbers for PCA initiated calls in accordance with one embodiment. A subscriber may tap or select a MyNumber field to bring the illustrated list of MyNumbers is displayed to allow the subscriber to tap or select a MyNumber phone entry as an origination number for a call. In the illustrated example, “iPhone+6595558725” is been selected as the current origination number as indicated by the check mark. The origination phone number directory may also include VoIP phone numbers, a current IP address of the mobile device, or any other type of number suitable for use to make a call. For example, in a WiFi area or zone, the mobile device may be assigned an IP address that the subscriber may use for making phone calls to a PSTN phone number or another IP address (via e.g., SIP or VoIP).

FIG. 1B presents an origination phone number drop down directory where each origination phone number has a location tag demarked by a greyed out arrow to the left of each origination phone number. Each origination phone number may be configured with and associated with a location tag. The PCA client and service (or a PCA server) is operable to keep track of the mobile device's physical location and location specifics of the origination phone number are compared with the location of the mobile device. When the mobile device location matches a location associated with a given origination phone number, the PCA client is able to automatically select the given origination phone number as the “current” origination number for PCA initiated calls or a phone number for receiving phone calls by the user of the mobile device when at a certain location (e.g., a redirected call). In FIG. 1B, an exemplary PCA GUI interface for a MyNumber drop down box is presented, which displays a geo tag symbol on the right of “iPhone+6595558725,” indicating that this number is geo tagged. The geo tag symbol identifies “iPhone” as the telephone number that matches the current location of the subscriber or mobile device. In one embodiment, “iPhone” is automatically selected as the origination number for PCA calls by the PCA client. When the subscriber changes locations (e.g., moves to another location), the origination number may automatically change to ensure that a PCA-initiated call is received at a correct machine or telephone given the subscriber's location.

A subscriber may make calls (either one-to-one or conference) by sending a request to a call server. The request includes information used to set up a call connection such as an origination phone number, IP address, device ID, client ID, or any other identification number, and the destination phone number, IP address, device ID, client ID, etc. The call server is operable to create a call connection between any PSTN phone number, mobile carrier phone number, VoIP number, IP address, etc., and any combination thereof. Based at least on the origination and destination information, the call server can set up the call connection between circuit and packet switching networks using PSTN, SIP, or VoIP.

The location of a mobile device of a subscriber may also be used to determine how a call connection is created by the call server. A call connection learning system may be provided by the PCA client (or a PCA server) to determine optimal configurations or preferences that can be toggled by the PCA user for establishing call connections based on a given location of the mobile device. The location of the user's mobile device and a VoIP call quality indicator may be used to create a database of call connection settings and preferences. The call connection learning system may determine, for example, locations where VoIP is operational for a mobile device and whether it should be used and where VoIP is unavailable or should not be used. Call quality may be monitored by connection type (e.g., VoIP or mobile carrier) for when the mobile device is detected at specific locations by the PCA client to determine what type of calls is most suitable at the specific locations. Call quality ratings may also be given to call connection types for the specific locations and used to by the PCA client to determine how calls should be established when the mobile device is located in the specific locations. When, for example, the user travels, the PCA client may select VoIP functionality by location where it is determined as operational. In certain situations, if VoIP quality is low, even though the user selects VoIP, the PCA client may override or prompt the user if he or she is sure that they want to use VoIP and display a VoIP call quality rating. In another embodiment, call quality automatically may be measured automatically, matching quality to location and create a learning database, which selects automatically how to establish a call connection (e.g., via Session Initiation Protocol (SIP), VoIP, mobile carrier, etc.).

Location tagging may also be used in a conference call setting, where a subscriber or participant may “tap” or select a PCA conference E-mail or send a “join” SMS message to initiate a PCA SMS response message sent to the LDSP. The LDSP may connect a participant or subscriber to a conference call and provide the conference the participants' location information and that participants can also receive a visual indication of the subscriber's location and local time enhancing the social networking experience. The location coordinates of subscribers may be tracked by the PCA client when they perform phone-related actions such as calling and messaging. When a conference call request or setup is initiated, a subscriber hosting a conference call may request the location of other subscribers for participation in the conference call. The location of desired participants for the conference call may be useful to the host to ensure that the host does not set up a conference call at inappropriate times. For example, engineering firms and companies with people in remote locations could benefit from the PCA system which sends the call request to a central server along with location information ensuring the call connection service uses the appropriate satellite phone connection to connect the party. Location coordinates for remote employee management can be essential in dangerous work situations and environments.

According to another aspect of the present invention, location tagging of a phone call can also provide self-reporting of lost devices. A mobile device may include a PCA client and service with call scheduling, or under certain conditions, the mobile device may be configured to report itself lost by placing a call with location information that can be played to a subscriber receiving the call. In another embodiment, location tagging phone calls can also offer greatly improved children's safety as the PCA client and service can have call requests scheduled for after school on a schedule giving the called party (e.g., parent) the location of the child ensuring that the child is safely where they should be and automating the process of finding them if they are not.

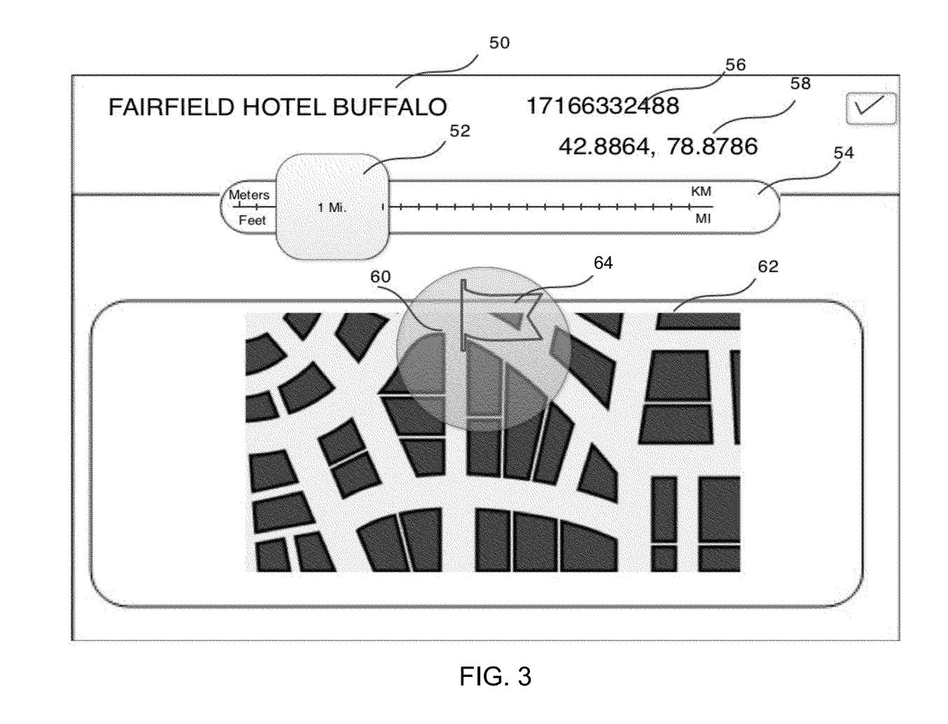

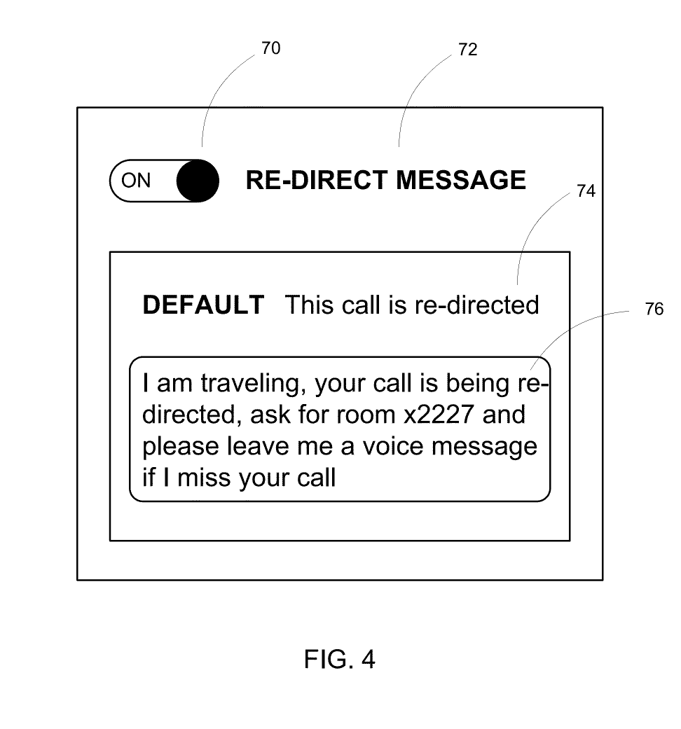

FIG. 2 presents setting for a given origination phone number. According to one embodiment, the subscriber can customize the functional properties of each origination phone number. In the illustrated example, a settings panel displays a MyNumber for a United States (U.S.) number. The number may be configured by the subscriber to forward a PCA call to telephone number “17166362488” when the subscriber is in the U.S. at, for example, a telephone number at the Fairfield Hotel. Turning “Auto Forward MyNumber” to “ON” automatically forwards calls directed to the subscriber's mobile device (default number, e.g., “iPhone”) to a current MyNumber configured to “MyNumber USA,” as illustrated. By pressing the associated chevron next to the “MyNumber USA,” a next settings panel depicted in FIG. 3. displays settings options for a geo tag associated with the MyNumber.

FIG. 3 presents a GPS location zone for a geo tag associated with an origination phone number in accordance with an embodiment of the present invention. The GPS location zone includes latitude and longitude coordinates (58) associated with a subscriber's current origination number 56 and physical location at the Fairfield Hotel 50 in Buffalo, N.Y., U.S.A. This location coordinate is provided by, for example but not limited to, mobile device GSM capabilities and integrated with PCA so that origination numbers can be tagged by location. The subscriber in this instance can elect to expand the zone corresponding to the current origination number (Fairfield Hotel) to the entire city of Buffalo by sliding the slider bar 52 of slider 54 to the right. The subscriber is provided a graphical map 62 with the exact location of the subscriber, for example, within 10 feet as indicated by the location flag 64.

Superimposed over the location flag 64 is a circular field providing a location zone reference 60 or radius that can be expanded as the slider bar moves to the right and contracted as the slider bar is moved to the left. For example, the subscriber may select 50 miles as an origination number zone for the Fairfield Hotel so that the subscriber will not receive phone calls at, for example, the subscriber's default origination number (“iPhone”) while the subscriber is within the 50 mile radius (location zone), but instead, all calls directed to the subscriber will be automatically diverted to the origination number associated with the Fairfield Hotel where the destination (called party) may also receive a re-direct message. If the subscriber moves outside beyond the 50 mile radius of the location zone, all calls will automatically revert to the subscriber's default origination number (e.g., “iPhone+6595558725”) if another geo tagged origination number matching the subscriber's location does not exist.

There are some situations where the called party will connect to an operator instead of the caller directly or to a third party, which can lead to confusion for the called party. To prevent this, a redirect message optionally can be sent to the calling party, letting them know their call is being redirected and to provide enough detail to eliminate any calling confusion brought about by the redirected call.

Referring back to FIG. 2, if the auto forward MyNumber toggle button on a given subscriber's PCA client settings is set to “ON,” then when a second PCA subscriber calls the default MyNumber of the given subscriber, the LDSP call connection process may check a MyNumber data record and associated re-direct message. The LDSP checking the MyNumber data record includes determining a MyNumber and associated redirect message. The re-direct message may be sent in any data format such as SMS to the called party to inform that the call is being re-directed and the LDSP then connects the called party to the re-directed number. The re-direct message can also be a message played to the called party as the call is being connected to the caller (in a PCA-initiated call) or played to a caller to the subscriber.

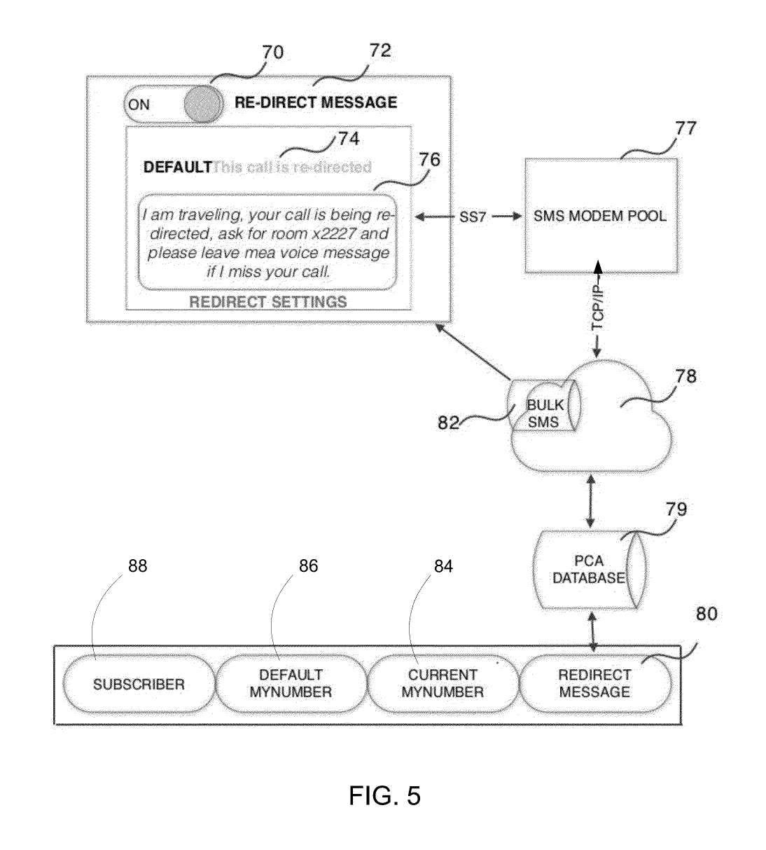

FIG. 4 presents exemplary components of a re-direct message in accordance with an embodiment of the present invention. In the above example where the subscriber origination number is a hotel number, the subscriber can set the redirect toggle button 70 to “ON” and enter a custom re-direct message 76. A custom re-direct message content 76 may be created by the subscriber in the redirect settings screen 72. If a custom re-direct message is not entered, a default re-direct message 74 is used. The PCA client or service forwards the origination number and the associated redirect message in a TCP/IP or SMS/USSD data format to the LDSP which uses the subscriber redirect information to update the subscriber MyNumber data field and associated re-direct message.

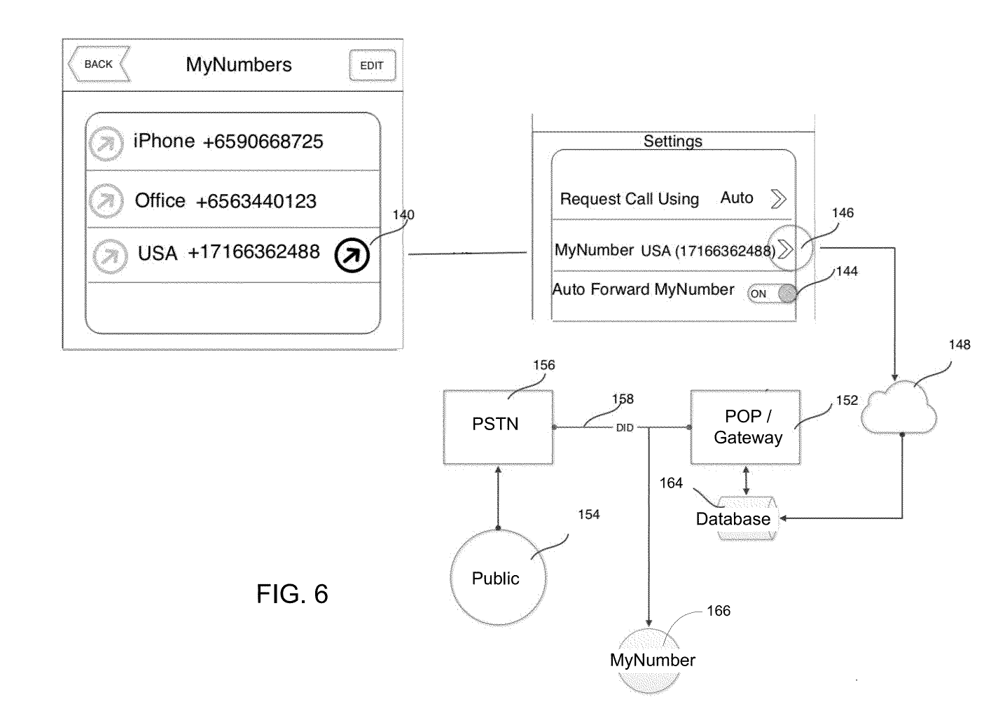

FIG. 5 presents a call flow diagram of a method for receiving redirect messages in accordance with an embodiment of the present invention. Once configured, the PCA client or server may automatically create a redirect message (e.g., a SMS) associated with the MyNumber, store the redirect message, and send the message to a SMS modem pool 77, as illustrated in FIG. 5. A subscriber 88 may configure a current MyNumber 84 different from a default MyNumber 86 with an associated redirect message 80 and the redirect message may be stored in a PCA database 79. The PCA database 79 may send the called party the redirect message 80 (content of re-direct message 76) associated with the current MyNumber 84 either to the SMS modem pool 77 and then from the modem pool 77 to the called party via PSTN Signaling System No. 7 (SS7), or to a bulk SMS provider 82 on network 78 and the bulk provider 82 sends the SMS to the called party.

Network 78 may be any suitable type of network allowing transport of data communications across thereof. The network 108 may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. In one embodiment, the network may be the Internet, following known Internet protocols for data communication, or any other communication network, e.g., any local area network (LAN), or wide area network (WAN) connection, wire-line type connections, wireless type connections, or any combination thereof.

According to one embodiment, the modem pool 77 may have country specific SIM cards. For example, if the subscriber is in the U.S. and the current subscriber origination number is country code 1 (using the Fairfield Hotel example), the PCA can search for an SMS modem pool receiving number with matching country codes (1) to avoid international SMS charges. Accordingly, information can be sent to and from the PCA application using “data roaming off” inexpensively, by sending SMS messages locally and in some cases internationally, but usually with matching country codes to avoid international SMS charges. Sending data back to the subscriber such as redirect messages can be accomplished by sending PCA database generated redirect message 80 to the modem pool 77.

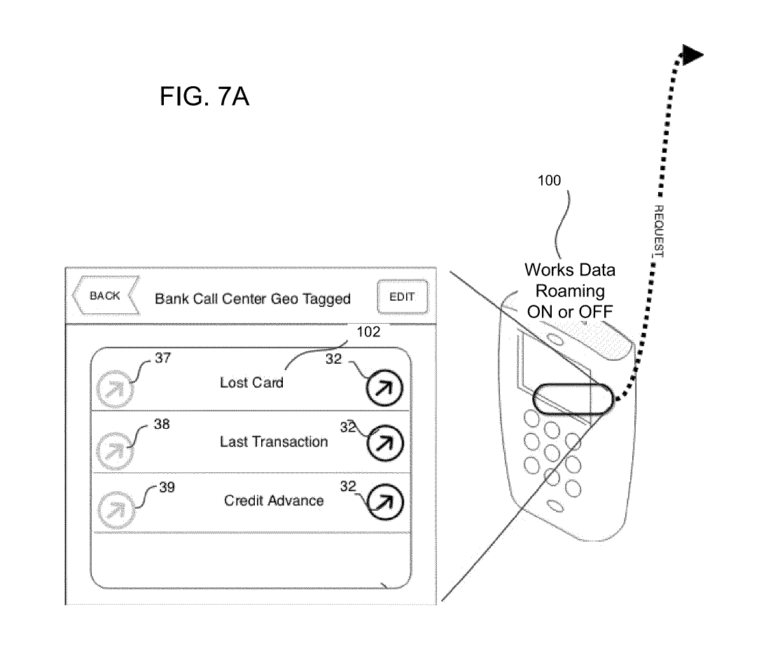

FIG. 6 presents a call flow diagram of call re-direction where a caller, either public or another PCA user/subscriber, is re-directed to a subscriber's current origination phone number in accordance with an embodiment of the present invention. A geo tag symbol 140 identifies “USA” as the telephone number that matches the current location of the subscriber. Enabling “Auto Forward MyNumber” 144 allows for calls directed to the subscriber's mobile device to be forwarded to the current MyNumber. A caller from a public landline 154 (or any non-PCA enabled device) may call the subscriber's mobile device default number through PSTN 156. The subscriber may forwarded his/her mobile device number to a LDSP DID number 158, and on the ring, the Post Office Protocol (POP)/gateway server 152 of the LDSP, holds the call, retrieves a MyNumber redirect number configured via setting 146 and an associated redirect message stored on a database 164 (such as a PCA database), forwards the call (in this example, to the Fairfield Hotel number 166) and plays the redirect message to the caller to avoid confusion before the call is completed to the Fairfield Hotel.

Location Detection with Disabled Data Roaming

One feature of the PCA according to an embodiment of the present invention includes functionality with data roaming off or disabled. In certain situations, people may turn data off on their mobile devices while roaming, however, GPS may still be active or enabled to continue to track the location of the mobile devices. The PCA application may enable or keep GPS services on a mobile device while data roaming is off and extract location coordinates (with permission or not) when the user performs certain actions such as making a phone call or sending a message for example. This feature may be enabled in situations such as when a user sends an emergency message (e.g., SMS) to a close relation or an emergency contact, make an emergency call, send an email indicating the user's position on a map to one or several contacts, publish an emergency message on the user's Facebook wall, or an application that allows the user to find a defibrillator, a doctor, a pharmacy, a hospital, a dentist, etc., to automatically get the coordinates of the user automatically. In one example, a parent can track daughter backpacking around the world, and her location data could be tracked based on phone calls and messages that are kept by the PCA service in, for example, the PCA database and can be made available in emergency situations or by selection by the user. In other embodiments, this feature may also be made available in banking and airlines and logistic companies. Sending messages from the mobile device to a PCA Database 79 may be done using a mobile device with “data roaming off,” data channels. For example, if Wi-Fi is available, the PCA application may detected that that channel is available and send the re-direct messages to the PCA database 79 via Wi-Fi, but if Wi-Fi is not available, another channel is used. For simplicity, reliability and universal capability, SMS and USSD messages can be primarily used to send re-direct messages to the PCA database.

Location Tagging Calls for Call Centers

A call center can deploy a version of PCA for their own subscribers or a Software Development Kit (SDK) so that PCA functionality can be embedded into a call center client application. Airline, logistics companies, travel agencies, emergency response groups are just a few examples of organizations who all have a vested interest as does the subscriber in the call center support organization to know the caller location before the call is connected to an agent. For phone number location tags to be effective when connecting to a call center, the LDSP may connect to the call center agent first and provide the agent the location of the caller before connecting to the caller, this way the agent can maximize the value of knowing a caller location before connecting to the caller. When the PCA sends a call request packet to the LDSP, the rules of connectivity for this particular call center could be to profile the client based on their membership number, origination number, or mobile number included in an information packet, and connect to the agent first if they are, for example, premium clients, and present the agent the location information of the caller.

The agent may be able to identify the caller by a combination of a trusted location and, for example, a membership number. The agent can also determine if the location has a “state of emergency” classification and if so, the agent can be well prepared before connecting to the caller. Consider travel agencies today make their fees from hotel and car booking not ticket sales. A travel PCA could easily locate a caller and the agent would be fully prepared to provide information on the closest travel agency-supported hotels and rental agencies. The agent can input the caller location in an airline database or Google Maps for example to determine “nearby facilities” that the airline has special service arrangements with, so that the agent is prepared to offer hotel or car booking advice and service along with airline ticketing services. With the location information the agent is prepared to find a hotel in close proximity, provide directions to the airport and be appraised if the caller is an emergency declared zone. The location information provides an opportunity to greatly improve premium client service levels, and offer another service like nearby hotel booking, increasing revenues for the airline. There is also a feature for regular clients to opt-in to the premium call center program on a per fee basis enabling call centers to charge for premium location services.

In one example, a bank knowing a client location can set up “trusted call from locations” such as home, or office where credit card billing information matches caller location information allowing automation of services resulting in more accurate client verification. Banks can also better profile clients frequent travel patterns to more accurately determine fraudulent situations. For lost card support knowing where a caller is calling from and matching that location to a card return geo tag can increase security. Logistics companies can take a phone delivery order and know in advance the exact address of delivery if they receive location tagging of the phone call in advance of connecting to the caller eliminating miscommunication and greatly shorten the length of time it takes to take an order. Emergency support services would know the location of a caller from anywhere in the world, expanding the capability of emergency service where currently only very few services in a small geographic area can determine a callers location from a phone call such as the U.S. “911” service which does not work outside the U.S. or include all phones in the U.S.

In another example, an agent at a call center can determine that a traveling passenger is in downtown, New York when the passenger is suppose to be at the airport. The passenger may launch an application to send a text message or a TCP/IP message to a call center. The application is operable to extract location coordinates of the user via GPS with data roaming on or off. The coordinates may be sent to a call center along with a connection request to the cell center. The coordinates may be push to the agent in a digital map display, e.g., Google Map, to the agent. Using the coordinates, the agent is able to arrange a hotel close to the downtown, New York location and check alternative flight information before establishing a connection between the agent and the passenger in response to the connection request.

In yet another example, a user may be involved in an accident. The user may send an SMS or TCP/IP message including “accident” or “emergency” and certain key words to trigger an application to extract the location/coordinates of the user and sends it to an agent along with any other particulars. The coordinates may be sent to a call center along with a connection request to the cell center. Using the coordinates, the agent may contact emergency services and send for help or assistance.

According to another aspect of the present invention, in a situation where a large volume of people are calling at the same time and overloads a call center, call processing of the call requests can be matched to available agents so calls are not dropped or overflowed such that in an emergency, a plurality of callers can be grouped into location zones and rank them according to risk by location ensuring genuine emergency cases are handled with priority. Even without taking the call or talking to the callers, location based emergency assistance can be dispatched when voice communications are not possible, which can significantly improve emergency response.

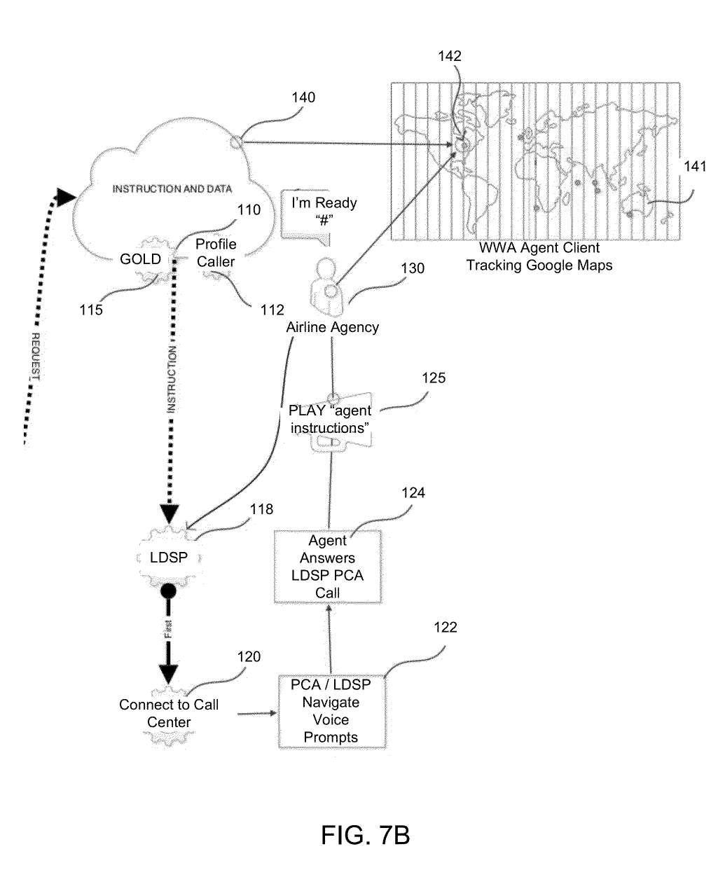

FIG. 7A and FIG. 7B illustrate calls to a call center using location tagging. A subscriber may use a PCA supplied by a bank optimized for connecting subscribers by phone to the bank call center and at the same time providing the location coordinates of the subscriber to the bank agent by selecting an appropriate connection request. Location tags 37, 38, and 39 may be configured for a lost card request, a last transaction request, and a credit advance request, respectively. For example, a subscriber may select lost card request 102 to connect to the bank call center. The PCA call center application 100 may send a call request packet to the LDSP cloud 110, providing connectivity instruction and data. The caller (subscriber) is profiled and a connectivity rule for “Gold” members 115 is sent to the LDSP 118. The LDSP invokes a call center connection process 120, creating a Dual-Tone Multi-Frequency signaling (DTMF) dial string appropriate to navigate the call center voice prompts 122 to connect to the airline agent 130.

When an agent answers the call 124, the LDSP optionally provides the agent subscriber information 140 or sends it to the agent in message format and at the same time passes the data to an airline client tracking database which displays a Google Maps pop-up 141 showing the details of the subscriber current location 142. In the case of a bank subscriber reporting a lost card, knowing exactly where the subscriber is can help pin point where the card was lost, where to send a new card, and how to direct the subscriber to the nearest help facility (playing “agent instructions” 125). In addition, location information for emergency call centers is very important as subscribers in high stress situations may not be able to provide proper location information but a location phone tag (geo tag) may be accurate to, for example, ten feet and can assist in dispatching help during emergency situations.

FIGS. 1 through 7B are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for provisioning location coordinates for phone calls, the method comprising:
associating locations of a mobile device with origination phone numbers, the origination phone numbers being either public switched telephone network (PSTN) mobile device phone numbers or a current Internet Protocol address of the mobile device;
determining a location of the mobile device;
selecting one of the origination phone numbers based on the determined location; and
directing call connections to the selected origination phone number.

2. The method of claim 1 further comprising initiating a call connection with the selected origination phone number.

3. The method of claim 2 wherein the call connection is a public switched telephone network callback call.

4. The method of claim 2 wherein the call connection is a voice over Internet protocol (VoIP) call.

5. The method of claim 2 wherein the call connection is a session initiation protocol (SIP) call

6. The method of claim 2 wherein the call connection is a conference call comprising VoIP, SIP or PSTN connectivity.

7. The method of claim 6 further comprising:
tracking location coordinates of mobile devices upon a given action associated with the mobile devices including at least one of a phone call and sending a message;
receiving a request for locations of the mobile devices for the conference call by a conference call host; and
providing the conference call host with the locations of the mobile devices.

8. The method of claim 1 further comprising:
configuring redirect messages for the origination phone numbers; and
providing a given one of the redirect messages corresponding to the selected origination phone number to callers of the directed call connections.

9. The method of claim 1 wherein determining the location of the mobile device includes determining whether the mobile device is within a location zone associated with a given one the origination phone numbers.

10. The method of claim 9 wherein the radius of the location zone is configurable by a user of the mobile device.

11. The method of claim 9 further comprising determining that the mobile device is not within a location zone associated with the origination phone numbers

12. The method of claim 9 further comprising:
selecting the default origination phone number based on the determination that the mobile device is not within the location zone associated with the origination phone numbers; and
directing the calls to the default origination phone number.

13. The method of claim 1 further comprising:
maintaining location detection while data roaming is disabled on the mobile device; and
extracting location coordinates of the mobile device upon a given action including at least one of a phone call and sending a message.

14. The method of claim 1 further comprising:
determining call quality ratings by connection type for given locations of the mobile device; and
identifying suitable call connection types to establish call connections to the mobile device at the given locations.

15. Non-transitory computer readable media comprising program code that when executed by a programmable processor causes execution of a method for provisioning location coordinates for phone calls, the computer readable media comprising:
computer program code for associating locations of a mobile device with origination phone numbers;
computer program code for determining a location of the mobile device;
computer program code for selecting one of the origination phone numbers based on the determined location; and
computer program code for directing call connections to the selected origination phone number.

16. The computer readable media of claim 15 further comprising:
computer program code for configuring redirect messages for the origination phone numbers; and
computer program code for providing a given one of the redirect messages corresponding to the selected origination phone number to callers of the directed call connections.

17. The computer readable media of claim 15 wherein the computer program code for determining the location of the mobile device includes computer program code for determining whether the mobile device is within a location zone associated with a given one the origination phone numbers.

18. The computer readable media of claim 17 further comprising computer program code for determining that the mobile device is not within a location zone associated with the origination phone numbers

19. The computer readable media of claim 18 further comprising:
computer program code for selecting the default origination phone number based on the determination that the mobile device is not within the location zone associated with the origination phone numbers; and
computer program code for directing the calls to the default origination phone number.

20. A method for provisioning location coordinates for phone calls, the method comprising:
receiving a request from a user of a mobile device for a service from a call center;
determining a location of the mobile device for the request;
transmitting the request with the location of the mobile to the call center, wherein the location is utilized by an agent of the call center to fulfill the service; and
receiving a call connection on the mobile device from the call center.

21. The method of claim 20 wherein the request comprises at least one of a banking service, an emergency service, a travel and lodging service, and a logistics service.

22. The method of claim 20 wherein the request includes geographical coordinates of the user and a phone number associated with the mobile device.
